(19) United States
(12) Patent Application Publication
(10) Pub. No.: US 2012/0293465 A1
(43) Pub. Date: Nov. 22, 2012

(54) SOLUTION FOR LOCATION BASED NOTIFICATION OF INTELLIGENT DISCOVERY APPLICATION TO USER

(76) Inventors: Ankur Nandu, Mumbai (IN); Kayshav Dattatri, San Jose, CA (US); Venkata Kumar Achyuta, Santa Clara, CA (US); David S. Stephenson, San Jose, CA (US)

(21) Appl. No.: 13/111,467

(22) Filed: May 19, 2011

(51) Int. Cl. G09G 5/00; H04W 4/00

(52) U.S. Cl. 345/204; 370/328

(57) ABSTRACT

In accordance with an example embodiment, there is disclosed herein an apparatus including a processor, a data storage in data communication with the processor, a display, a wireless data transceiver, and a display driver. The data storage is operable for storage of application programs and application data. Identification data is disposed in the data storage, wherein the identification data is uniquely associated with the wireless data transceiver. The wireless data transceiver is operable to broadcast the identification data to at least one associated wireless access point having a predefined location relative to an associated premises prior to establishing a networked data connection therewith, and is further operable to receive notification data, responsive to broadcast identification data, from an associated networked data server. The display driver is operative to display data corresponding to the received notification data on the display.

### TECHNICAL FIELD

The subject application is directed generally to communication of targeted information to end users. The application includes an embodiment wherein a user carrying a device such as a cell phone, smart phone, personal digital assistant (PDA) tablets and eReaders or other wireless device is provided with information, such as product information, location and routing information, coupons, sale information, or inventory information, upon entry into a vicinity of a particular premises or location.

### BACKGROUND

Wireless products are ubiquitous in today's society. Many of such devices have different, alternative transceiver capabilities. By way of example, devices may be able to communicate via cellular networks implementing technologies such as GSM or CDMA. Devices may also be able to communicate via Bluetooth technology, near field communication, RFID, or 802.11x protocols. Devices also include fourth generation communication technology, some of which are implemented with WiMAX, Long Term Evolution (LTE), or other high-speed data network technology. Devices that are also being carried include book readers, such as the Amazon Kindle and tablet computers, such as the Apple iPad. These devices also include wireless connectivity, such as via one or more of the afore-noted connectivity options. Many establishments are currently providing wireless connectivity to mobile devices at or near their premises as a convenience and added benefit or attraction to their customers or for other reasons. Such establishments include airports, train stations, hotels, stores, restaurants coffee shops and movie theatres, as well as shopping centers themselves.

### BRIEF DESCRIPTION OF THE DRAWINGS

The accompanying drawings incorporated herein and forming a part of the specification illustrate the example embodiments.

FIG. 1 is a schematic functional block diagram illustrating operation of a mobile wireless device relative to a single premises in accordance with an example embodiment.

FIG. 2 is a schematic functional block diagram illustrating operation of a mobile wireless device relative to multiple premises in accordance with an example embodiment.

FIG. 3 is a functional block diagram of a network system mobile device operable within the network system in accordance with an example embodiment.

FIG. 4 is a more detailed functional block diagram of the network system mobile device operable within the network system of FIG. 3 in accordance with an example embodiment.

FIG. 5 is a block diagram illustrating an example of a computer system upon which an example embodiment can be implemented.

FIG. 6 is a flow chart illustrating a method of operation in accordance with an example embodiment.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with one representative example embodiment, a system and method is provided wherein a location, such as a retail location, publication location, commercial establishment, or the like is able to provide direct and targeted data communication to individuals who approach or enter a particular location with a wireless data device. This provides, among other things, an opportunity for a purveyor of goods, services or premises access to provide relevant information to visitors or consumers, such information as to particular products or services or features of the premises that may be of interest to the individual.

In accordance with an example embodiment, there is disclosed herein an apparatus comprising a processor, a data storage in data communication with the processor and operable for storage of application programs and application data, a display, a wireless data transceiver, and identification data, disposed in the data storage. The identification data is uniquely associated with the wireless data transceiver. The wireless data transceiver is operable to broadcast the identification data to at least one associated wireless access point having a predefined location relative to an associated premises prior to establishing a networked data connection therewith. The wireless data transceiver is further operable to receive notification data, responsive to broadcast identification data, from an associated networked data server. A display driver is operative to display data corresponding to received notification data on the display.

In accordance with another example embodiment, there is disclosed herein a method comprising, storing an application on a portable data device, the application having an application identifier associated therewith, registering device identification data corresponding to the portable data device on a networked server associatively with the application identifier, broadcasting an electromagnetic signal inclusive of the device identification data to at least one wireless access point associated with the premises, communicating device identification data received by the at least one wireless access point to the networked server, retrieving, via the networked server, premises data corresponding to the application identifier in accordance with received device identification data, and communicating the premises data to the portable data device via the at least one wireless access point.

In accordance with a further example embodiment, there is disclosed herein a system. The disclosed system comprises means for storing an application on a portable data device, the application having an application identifier associated therewith, means for registering device identification data corresponding to the portable data device and on a networked server associatively with the application identifier, means for broadcasting an electromagnetic signal inclusive of the device identification data to at least one wireless access point associated with the premises, means for communicating device identification data received by the at least one wireless access point to the networked server, means for retrieving, via the networked server, premises data corresponding to the application identifier in accordance with received device identification data, and means for communicating the premises data to the portable data device via the at least one wireless access point.

It will be appreciated to one of ordinary skill in the art that the embodiments disclosed herein are suitably practiced under any suitable hardware and software environment, including any suitable data server working in conjunction with a wireless data connection in data communication with a portable wireless data processing and communication device. The subject application includes an embodiment incorporating an environment particularly suited for use with Cisco Systems' Cloud Computing architecture. The subject application further includes an embodiment particularly suited for use in conjunction with the Cisco Mobility Services Engine (MSE) platform for provisioning and managing mobile services.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

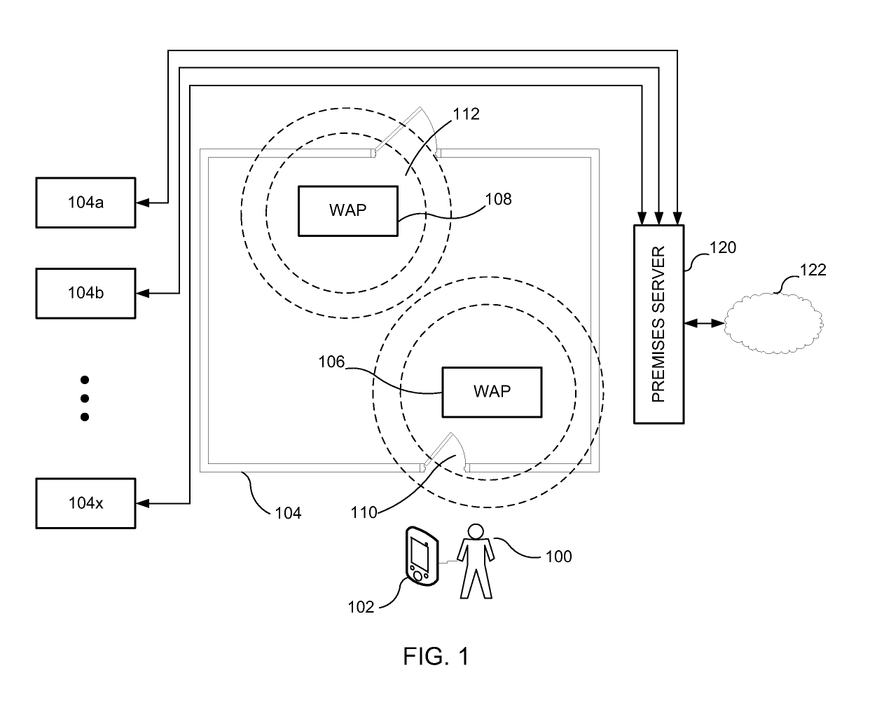

In accordance with an embodiment of the forgoing and in conjunction with FIG. 1, a patron 100 is in possession of a digital communication device 102 as they approach or arrive at a location 104. The device is suitably a cell phone, smart phone, PDA, tablet, or any other suitable portable, wireless data device. Portable devices typically include the components of a general purpose digital computer, albeit in a more compact, lightweight, ergonomic or energy efficient form. Devices include an operating system that forms a platform upon which applications can be installed and run. Earlier devices, such as smart phones, frequently ran on mobile or lightweight operating systems such as the BlackBerry environment of Research In Motion, or the Windows Mobile environment of Microsoft. More recently, a large number of devices utilize the Apple iOS used in its iPhone product or the open source Android operating environment. These platforms afford an end user the ability to select and install applications that provide functions, connections or other features uniquely desired by each device owner. Both operating environments offer associated networked locations where a user can obtain, download or purchase, and install, applications (“apps”) for use on their mobile device. Such locations are frequently referred to as application vendors.

The premises 104 includes one or more associated wireless data transceivers, two of which are illustrated at 106 and 108 as wireless access points (WAPs). It will be appreciated that any number of wireless data transceivers are suitably used implementing any suitable wireless data communication scheme. One embodiment suitably employs a portable device that communicates via an 802.x protocol. Still further embodiments suitably employ any wireless communication system that allows for a determination of a presence and relative position of a mobile user relative to at least one premises. Other embodiments suitably include Bluetooth communication, cellular phone communication or femtocell communication. Any suitable communication system wherein a complementary transceiver associated with a premises is suitably implemented.

Implementation of multiple wireless data transceivers allows for determining whether a user/device is close to a particular entrance, such as illustrated at 110, 112, or whether they are at a particular location or in a particular area of a premises. In the illustrated embodiment, the data transceivers are in data communication with a premises server 120 and with an extended data network such as is illustrated at cloud 122. The details associated with an extended network connection via cloud 122 will be set out below.

With reference to FIG. 1, one or more additional premises 104a, 104b . . . 104x are illustrated. Each additional premises suitably includes its own wireless transceiver system (not shown) operable analogously to that of premises 104. These premises may be nearby or otherwise associated with the example premises 104, such as in the same shopping complex or mall, same general geographic location or related by common ownership or complementary offerings. In the illustrated embodiment of FIG. 1, the multiple premises 104 share a common premises server 120. It will be appreciated that each premises may suitably have as necessary or desired its own server which is able to communicate with the cloud 122, or two or more premises can suitably share a common server.

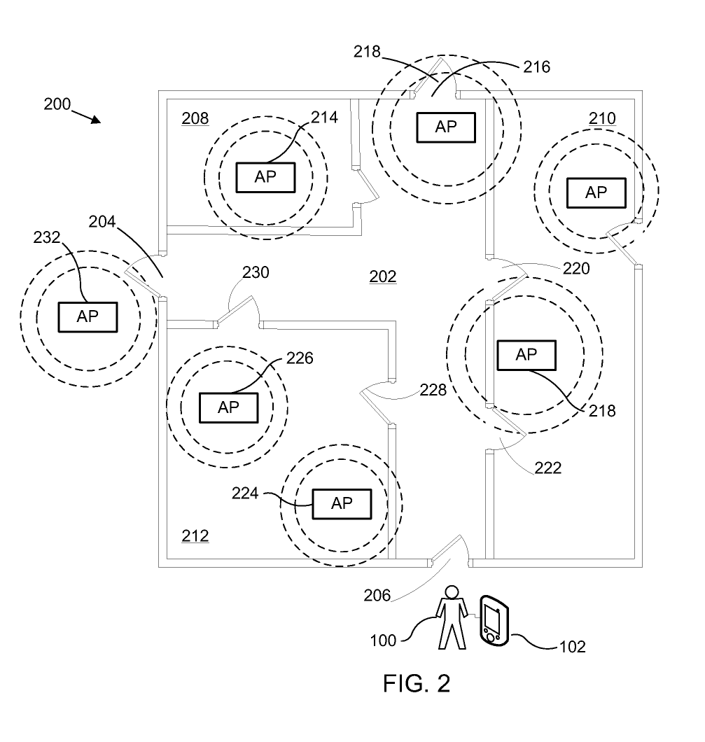

Turning now to FIG. 2, a further example embodiment is illustrated wherein multiple establishments are generally proximate to one another. In this embodiment, by way of example, a shared area 200 is suitably a retail center, such as a shopping center, mall or any location where multiple, yet distinct, areas are found or may be selected or identified as desired. Several possible configurations relative to the embodiment of FIG. 1 are illustrated. The shared area 200 suitably includes a shared common area 202, which common area suitably provides for ingress and egress via an entrance way 204, or any other suitable entrance, to alternative or interior entrances to premises 208, 210 or 212.

In the illustration of FIG. 2, an access point 214 is disposed within premises 208. In this setting, the access point 214 is positioned such that a digital communication device such as the device 102 would be subject to detection by the access point 214 while already positioned in the premises 208. Alternatively, relative positioning of access points are illustrated. In accordance with this, a further access point 216 is positioned so as to detect digital communication devices that approach, withdraw or otherwise move relative to an entry 218 of the common area 202. A still further access point 218 is positioned so as detect devices that approach, retract or otherwise move relative to either entry 220 or 222. Access points 224 and 226 are positioned so as to detect devices that approach entry 228 and 230, respectively. Access point 232 is illustrated as positioned to detect devices that are not disposed within or adjacent a structure, such as in an open area or a parking lot. It will be appreciated that any suitable positioning of an access points, or multiple access points is available in accordance with a particular application or situation.

As illustrated, information associated with users that are located in one premises is shared relative to one or more of the other premises, suitably via common data connection, such as through premises server 120 (FIG. 1) or via local area network, wide area network or Internet connectivity. Such system for data interchange allows for providing different information relative to the user carrying the digital communication device 102 once they enter one premises of several that are configured for data interchange or when they move the digital communication device 102 relative to the several premises.

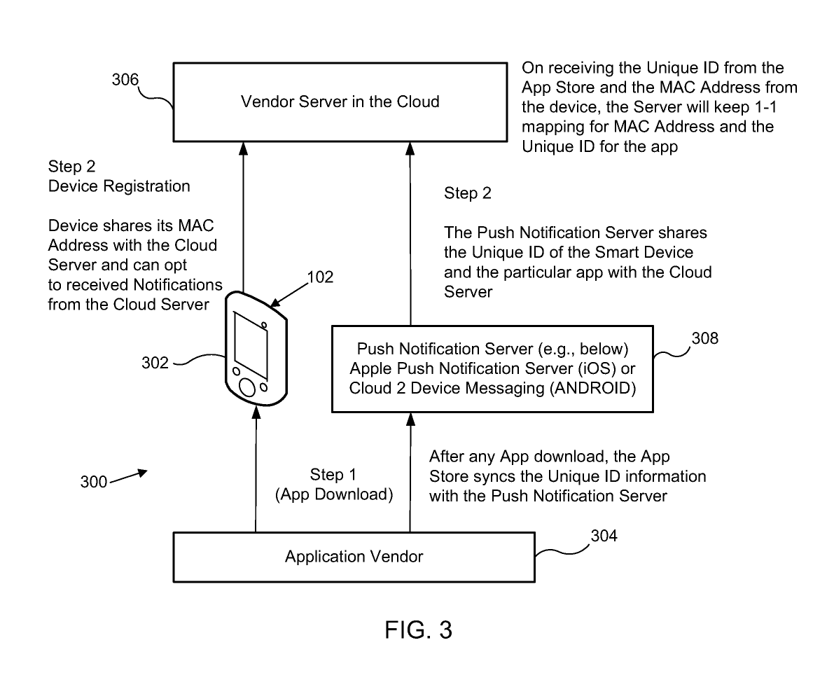

Turning now to FIG. 3, a communication device 102 in the form of a smart phone device 302 is operable in the functional environment 300 illustrated. In the illustrated representative embodiment, portable data devices 102 such as the device 302 having wireless communication capabilities typically include a system for discovery of wirelessly accessible systems. The basic capability to detect and connect with wireless networks and with cellular networks is usually provided as an intrinsic function of a mobile device and typically does not require installation steps but instead resides in the device when purchased as executive type software and/or firmware. An application to accomplish the functionality detailed below is suitably obtained and installed on the device 102 either as part of a customized executive software and/or firmware package or by additional installation steps. In one embodiment, the application to accomplish the functionality detailed below is obtained and installed from an application vendor such as that illustrated at 304. In a one particular embodiment involving Wi-Fi, a user's device 302 suitably broadcasts information to solicit a response from one or more complementary wireless devices, such as one or more wireless access points as described above, to determine whether a wireless connection is available between the devices. In such an embodiment, the portable device suitably broadcasts a device identifier such as its media access control (MAC) address, which address is an identifier uniquely assigned to and associated with each network device. As will be detailed further below, the subject application teaches an embodiment that utilizes a broadcast of a device unique identifier (UDID) to accomplish, with a high degree of fidelity, recognition of registered devices, association of information with recognized devices and communication of targeted information relating to a particular premises when a data connection is thus established. In the illustration of FIG. 3, the device identifier, such as the device MAC address, is registered at a network server, suitably a vendor's server disposed via wide area network connectivity, such as the Internet, or with any other selected or designated network. Registration of the device identifier associatively with information corresponding to the installed application and associated vendor allows for pushing of premises specific data to the portable data device as will be described in further detail, below. The registered device identifier may include a serial number of the device or an identifier derived from the device serial number, MAC address, or any other similar identifying information unique to the device.

By way of example, in a representative iPhone environment, a user of a smart device user suitably downloads a discovery application for their portable device 302. The functionality of a suitable discovery application is described in greater detail, below. In the illustrated embodiment of FIG. 3, the discovery application is suitably obtained from an application store or from a download source 304 corresponding to an end user's particular device.

Once an appropriate discovery application is downloaded and installed on the user's device 302, a notification server disposed on the device provides a premises server 306 with its device unique identification element. By way of example, in an Apple iOS environment, notification server functionality is suitably accomplished by delivering its DeviceToken value to the server. In the Android environment, notification server functionality is suitably accomplished with its RegistrationId value as the device unique identifier (UDID). The MAC address is suitably obtained from the smart device as well, along with the corresponding device identification element such as, for example, various hardware, software and/or firmware identifiers such as the device serial number, so that, at the premises server level, the smart device is uniquely identified on the basis of its MAC address and it is suitably mapped in connection with a device identification element. In an example embodiment, the system selectively performs a mapping from the MAC address to the unique device identifier UDID wherein the UDID may be derived from a hash function based on MAC address information, serial number, or any other identifier elements as necessary or desired, and stored for later use in the mapping.

The device 302 is registered with the server 306 when the device 302 enters an environment or premises which have a suitable network communication and data infrastructure, such as with a Cisco Unified Wireless Deployment with Mobility Services Engine or other suitable system. Examples of entering, leaving, and moving relative to several premises, where described above in connection with FIGS. 1 and 2. The system suitably detects a location of the device at or within the premises. Once premises system 204 detects the presence of the portable device 102, it suitably contacts its associated server and informs it about the location of this newly detected smart device. Next, the server looks up its database for the MAC address of the smart device located and suitably finds its corresponding DeviceToken or other suitable device unique identifier (UDID).

By way of this example, using the DeviceToken or any other form of device unique identifier and an alert message, the system 300 pushes, via a push notification server 308, a notification to the notification server. The push notification server 308 thus commences forwarding of the alert message to the smart device 102. Once the smart device receives the alert message, any suitable alert is generated, such as with an up arrow on the screen, audible indicator, vibration of the device or message prompt should such an option be available and enabled. The user suitably decides to acknowledge or ignore the user alert message, and by doing so, the discovery application installed on the device is selectively activated, suitably in accordance with one or more user preferences that are or were previously set.

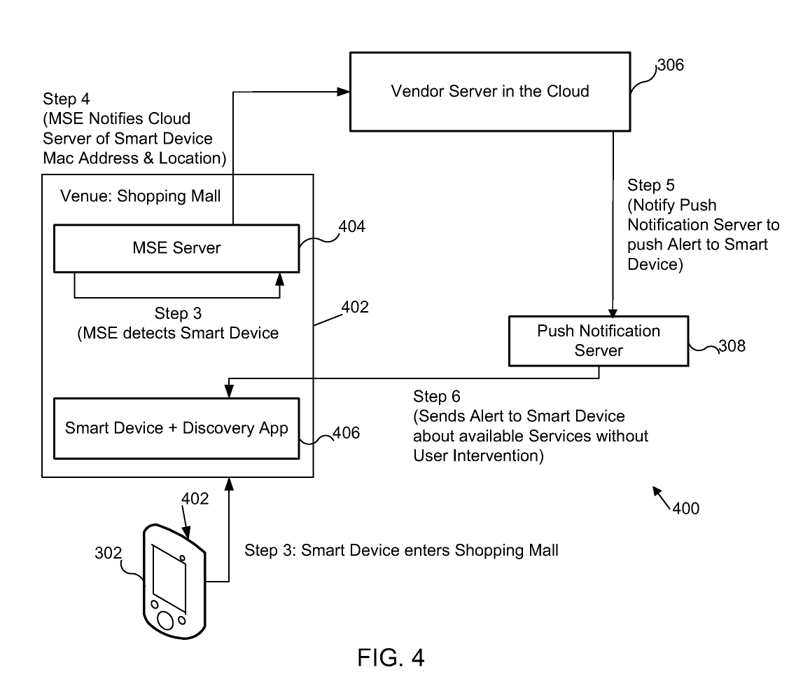

Turning now to FIG. 4, an embodiment of the subject application is illustrated in greater detail. In the system 400 of that Figure, block 402 illustrates interaction between the premises server, such as a Mobility Services Engine server 404 and a discovery application 406 associated with the device 302.

This afore-noted embodiment provides the functionality of a wireless infrastructure including one wherein the system, such as the Mobility Services Engine, functions to detect probing and associated Smart Devices and thereafter notifies one or more of the Smart Devices of available Local Services without any need for user intervention. The solution is able to bring in an entire Wi-Fi and/or cellular network infrastructure into play and can automatically notify the user to use the Discovery Application for relevant information instead of relying on the user to manually run the application. In one embodiment, access points provided with additional radio hardware and software for functionally supporting cellular network devices, selectively detect the presence of cellular devices even if the wireless network functionality of the cellular devices is turned off, defeated, or otherwise inoperable.

The subject system is further described in connection with the figures attached hereto. By implementing an asynchronous push operation of the notification to a user device, there is an increase in the chance of the user noticing the services available locally and thereby increasing the probability of using those services.

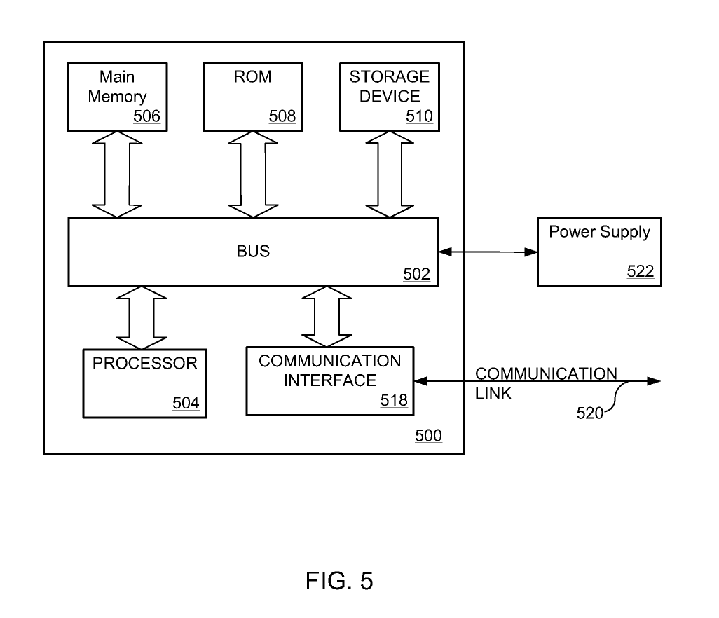

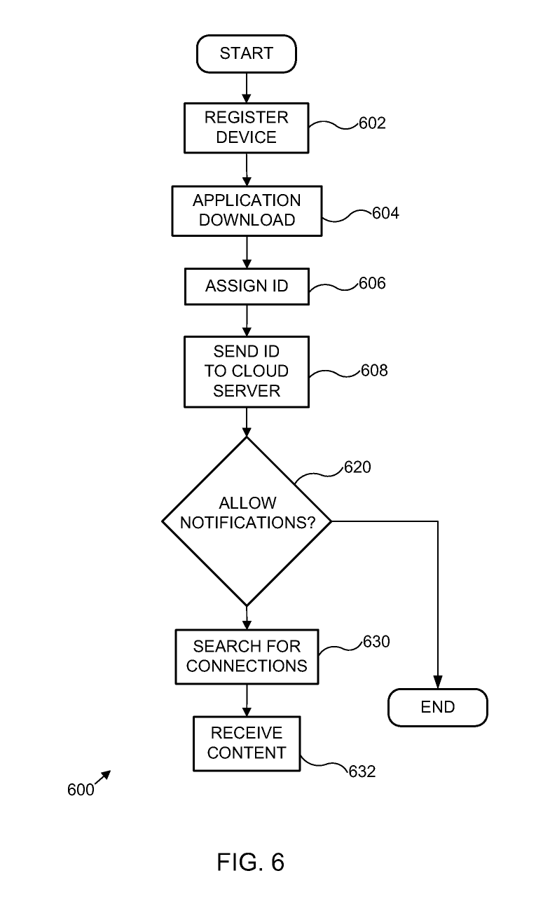

FIG. 5 is a block diagram that illustrates a computer system 500 upon which an example embodiment may be implemented. Computer system 500 may be employed to implement any one or more of the components of the system disclosed herein including for example any of the servers, user devices or access points shown in FIGS. 1-4, and to implement some or all of the methods disclosed herein including for example the method of FIG. 6.

Computer system 500 includes a bus 502 or other communication mechanism for communicating information and a processor 504 coupled with bus 502 for processing information. Computer system 500 also includes a main memory 506, such as random access memory (RAM) or other dynamic storage device coupled to bus 502 for storing information and instructions to be executed by processor 504. Main memory 506 also may be used for storing a temporary variable or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

An aspect of the example embodiment is related to the use of computer system 500 for location based notification of intelligent discovery application to users. According to an example embodiment, intelligent discovery information is provided by computer system 500 in response to processor 504 executing one or more sequences of one or more instructions contained in main memory 506. Such instructions may be read into main memory 506 from another computer-readable medium, such as storage device 510. Execution of the sequence of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 504 for execution. Such a medium may take many forms, including but not limited to non-volatile media, and volatile media. Non-volatile media include for example optical or magnetic disks, such as storage device 510. Volatile media include dynamic memory such as main memory 506. As used herein, tangible media may include volatile and non-volatile media. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other non-transitory medium from which a computer can read.

Various forms of computer-readable media may be involved in carrying one or more sequences of one or more instructions to processor 504 for execution. For example, the instructions may initially be borne on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506 from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling computer system 500 to a communication link 520 that is coupled with at least one other power supply module. This allows processor 504 to communicate with other power supply modules, for example to send/receive discovery, power master declaration and/or power budget messages.

Computer system 500 is also selectively coupled with a stationary power source (not shown) or a portable power supply device 522 such as a battery, solar cell, or the like for enhanced mobility when the system 500 is embedded into one of the user devices 102 described herein, for example. This allows on-board power regulators associated with computer system 500 to perform the functions of location based notification of intelligent discovery described herein.

With reference next to FIG. 6, a method 600 in accordance with an example embodiment for registering a device, and selectively pushing notifications to the registered device will be described. When a smart device, such as a phone or tablet, registers such as at step 602 with a corresponding application source, the user suitably downloads and installs an appropriate discovery application such as at step 604. When a smart device downloads or installs any application from an application source, the installed application is suitably assigned a unique identifier such as at step 606. This unique identifier is suitably the combination of the MAC Address of the Smart Device and the application identifier. When the discovery application and vendor application is downloaded, the application source suitably shares this unique identification data with the vendor and the cloud service provider such as at step 608. This completes the registration process.

Once this unique identifier is known, based on a suitable determination such as at step 620, the cloud server, and thus the vendor via the premises server is enabled to intelligently send any notification to the correct smart device and the appropriate application installed on it. The smart device user suitably elects, via the smart device, to receive or not to receive notifications from the cloud server at the time of registration. One embodiment implements the automatic detection of a smart device by the Mobility Services Engine in a unified Cisco WLAN Deployment and then alerting the user about the locally available Services without any user intervention.

In conjunction with operation in accordance with the forgoing, the following functionality is achieved. When Smart device 102 enters a location having a deployed wireless network such as with a WLAN deployment, such as malls, shopping complexes, stadiums, or public place, it will be automatically detected such as at step 630 and located by the system, such as the Mobility Services Engine, even if it is simply probing. On this detection, the premises system will evaluate if the device is a new one which has entered the deployment and send a notification to a server, such as a central server, with the device MAC address. The server suitably checks if this particular device (based on its MAC Address) has registered for the discovery application and server will be able to find the matching unique identifier and device application, and send a notification to the smart device about the availability of any local services, discounts, sales, premises information, store hours or other relevant information. The notification is sent using any suitable technology but, in the example embodiment, is sent using cellular techniques such as via 3/4G networks or by wireless techniques or technologies such as for example WiFi or the like. On receiving this notification (which has occurred without any user intervention) such as at step 632, the user can decide whether they want to avail of the offers or information communicated to them. If the user decides to avail of the Services, a suitable vendor application will launch automatically.

The subject system includes an embodiment that allows a user to receive intelligent services in the neighborhood once they actually connect to Internet or 3G/4G and then enable on the particular associated application on the Smart Device. This provides an embodiment having a wireless infrastructure which notifies the Smart Device of Intelligent Local Services without any need for user intervention. A suitable application is in connection with an auto-check in association with goods or services associated with a particular location.

In an embodiment wherein the Cisco Mobility Services Engine is used, detection is possible even if the user does not explicitly connect to any Wi-Fi network. Additionally, the location in an indoor environment is more granularly calculated such as to a particular entrance or location on the premises, helping to improve the quality and intelligence of Services offered based on the Smart Device Location.

The subject application includes an embodiment wherein a user may to opt in to receive such notifications. The subject application further includes an embodiment wherein two or more separate premises areas can share information, such when a common customer approaches. By way of example, a shopping mall suitably has a wireless access point disposed at one or more entrances. When a User approaches one entrance, that user's presence is suitably broadcast to multiple locations.

In systems wherein importance is given to battery life for Smart Devices and applications cannot run in the background, the subject teachings offers a unique way of providing granular local advertisements without the necessity of user intervention or applications running in the background.

The 802.11u support is further supported with appropriate drivers as will be appreciated by one of ordinary skill in the art. The subject application includes embodiments that provide intelligent services to User Devices without any intervention without the need for any driver upgrade. This idea applies successfully to any Smart Device, including devices which have Wi-Fi and 3G or 4G support.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus comprising:
a processor;
a data storage in data communication with the processor, and operable for storage of application programs and application data;
a display;
a wireless data transceiver;
identification data, disposed in the data storage, the identification data uniquely associated with the wireless data transceiver;
the wireless data transceiver being operable to broadcast the identification data to at least one associated wireless access point having a predefined location relative to an associated premises prior to the wireless data transceiver establishing a networked data connection with the at least one associated wireless access point;
the wireless data transceiver further being operable to receive notification data from an associated networked data server responsive to the identification data broadcast; and,
a display driver operative to display on the display data corresponding to the received notification data.

2. The apparatus of claim 1 further comprising a registration device operable to register the identification data with the networked data server prior to broadcast of the identification data.

3. The apparatus of claim 2 wherein the notification data is pre-associated with the predefined location prior to broadcast of the identification data.

4. The apparatus of claim 3 wherein the notification data includes data corresponding to the predefined location.

5. The apparatus of claim 4 wherein the predefined location is comprised of a retail establishment.

6. The apparatus of claim 5 wherein the notification data further includes data corresponding to a commercial offering of the retail establishment.

7. The apparatus of claim 6 wherein the notification data includes data selected in accordance with a comparison of the identification data with preselected end user criteria associated with the identification data.

8. A method comprising:
storing an application on a portable data device, the application having an application identifier associated therewith;
registering device identification data corresponding to the portable data device on a networked server associatively with the application identifier;
broadcasting from the portable data device an electromagnetic signal inclusive of the device identification data to at least one wireless access point associated with a premises;
communicating device identification data received by the at least one wireless access point to the networked server;
retrieving, via the networked server, premises data corresponding to the application identifier in accordance with received device identification data; and,
communicating the premises data to the portable data device via the at least one wireless access point.

9. The method of claim 8 further comprising selectively communicating the premises data to the portable data device in accordance with permission data received from an associated user.

10. The method of claim 8 further comprising communicating premises data to the portable data device to generate a display thereon.

11. The method of claim 10 wherein the communicating the premises data comprises communicating premises data corresponding to a retail establishment associated with the premises.

12. The method of claim 8 wherein the communicating the device identification data comprises communicating device identification data including a MAC address associated with the portable data device.

13. The method of claim 8 further comprising retrieving the premises data from a premises data server associated with the premise in accordance with data received from the networked server.

14. The method of claim 8 further comprising authenticating the portable data device with the at least one wireless access point after receipt of the device identification data by the at least one wireless access point.

15. A system comprising:
means for storing an application on a portable data device, the application having an application identifier associated therewith;
means for registering device identification data corresponding to the portable data device and on a networked server associatively with the application identifier;
means for broadcasting from the portable data device an electromagnetic signal inclusive of the device identification data to at least one wireless access point associated with a premises;
means for communicating the device identification data received by the at least one wireless access point to the networked server;
means for retrieving, via the networked server, premises data corresponding to the application identifier in accordance with the device identification data received; and,
means for communicating the premises data to the portable data device via the at least one wireless access point.

16. The system of claim 15 further comprising means for selectively communicating the premises data to the portable data device in accordance with permission data received from an associated user.

17. The system of claim 15 further comprising means for communicating premises data to the portable data device to generate a display thereon.

18. The system of claim 17 wherein the premises data corresponds to a retail establishment associated with the premises.

19. The system of claim 15 wherein the device identification data is comprised of a MAC address associated with the portable data device.

20. The system of claim 15 further comprising means for retrieving the premises data from a premises data server associated with the premise in accordance with data received from the networked server.
